(19) United States
(12) Patent Application Publication
(10) Pub. No.: US 2009/0063286 A1
(43) Pub. Date: Mar. 5, 2009

(54) System and Method for Payment of Services for the Non-Banking Sector Through a Multimedia Kiosk

(75) Inventors: Harold Alexander Rodriguez Porras, Caracas (VE); Luis Leonardo Rodriguez Porras, Caracas (VE)

Correspondence Address: MICHAEL J. BUCHENHORNER, 8540 S.W. 83 STREET, MIAMI, FL, 33143, US

(73) Assignee: HARPS, Caracas (VE)

(21) Appl. No.: 11/846,335

(22) Filed: Aug. 28, 2007

(51) Int. Cl. G06Q 20/00

(52) U.S. Cl. 705/24; 705/40

(57) ABSTRACT

A method for paying services includes steps or acts of: receiving a request for making a payment for a service; receiving a selection of the type of service to be paid and an account number; receiving identifying information from the consumer and the amount of the payment; and providing a payment voucher to be used as payment for the services.

### FIELD OF THE INVENTION

The invention disclosed broadly relates to the field of payment for services and more particularly relates to consumer payment for utility services and the like.

### BACKGROUND OF THE INVENTION

A large segment of the world's population has no access to bank and banking services. We call this segment the non-banking sector. The computerization of commerce (“e-commerce”) is a fast-growing trend. E-commerce involves making buying decisions, purchasing, and paying through computer networks and electronic banking means. Those who do not have access to banking services are left out of this e-commerce trend, yet in some countries this non-banking sector accounts for a majority of the population. Making payments for services such as telephone services or utility services is cumbersome and time-consuming for the non-banking sector. Normally, a person with no bank account must go directly to the service provider and make the payment with cash. As we move forward in the digital age, it is a shame that such a large segment of the population must still operate this way.

Therefore, there is a need for a system and method for facilitating the non-banking sector's participation in e-commerce and in payment for services.

### SUMMARY OF THE INVENTION

Briefly, according to an embodiment of the invention, a method for paying services includes steps or acts of: receiving a request for making a payment for a service; receiving a selection of the type of service to be paid; receiving identifying information from the consumer and the amount of the payment; and providing a ticket to be purchased in payment for the services.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a simplified illustration of a service payment system, according to an embodiment of the present invention;

FIG. 2 is a simplified illustration of a kiosk according to an embodiment of the present invention;

FIG. 3 is a flow chart of the method for paying for services, according to an embodiment of the present invention;

FIGS. 4a, 4b, 4c, and 4d are screenshots according to an embodiment of the present invention;

FIG. 5 is an exemplary illustration of a ticket, according to an embodiment of the present invention; and

FIG. 6 is a simplified block diagram of the components of a kiosk, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We describe a system and method for facilitating the electronic payment of services for the non-banking sector. According to an embodiment of the present invention, the system and method as will be described herein affords the non-banking sector a quick and easy way to participate in e-commerce by paying for services electronically.

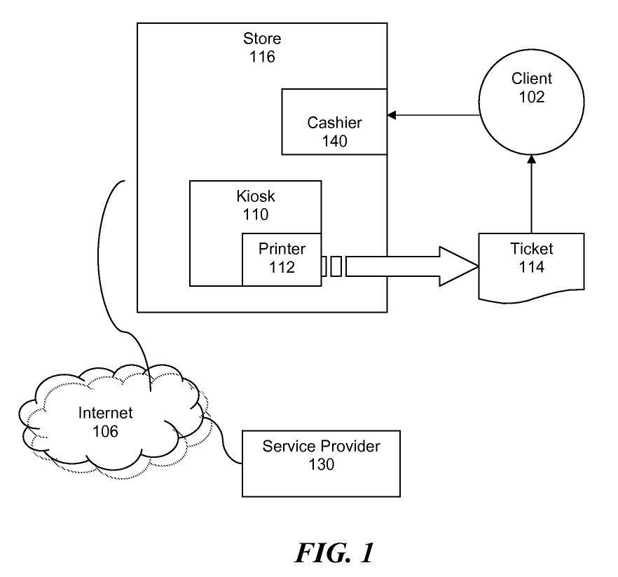

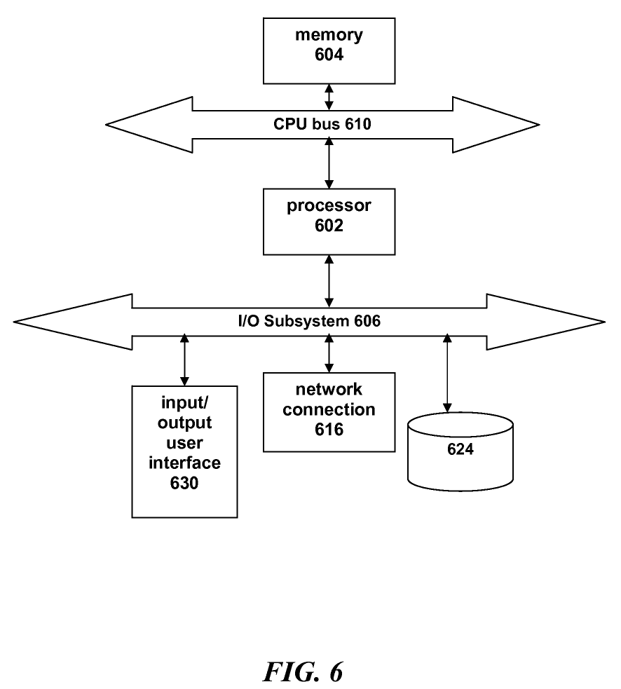

We now discuss an embodiment of the invention. Referring to FIG. 1, there is shown a simplified diagram of a system 100 for enabling e-commerce transactions for the non-banking sector. The system 100 works as follows: a consumer 102 can conveniently pay for the services of a service provider 130 using a kiosk 110 at a commercial establishment such as a grocery or convenience store 116. The kiosk 110 may be a stand-alone system or it may be coupled with a payment terminal at the cashier 140. In another embodiment, the kiosk 110 may be coupled with other payment kiosks, such as phone card kiosks. The kiosk 110 will be further described in the discussion of FIG. 6.

The consumer 102 may be a person who has no bank account, credit card, or other pre-established electronic payment means. The store 116 maintains a wireless connection to several service providers 130 via a wide area network (WAN), such as the internet 106 or the store 116 may use a virtual private network (VPN) link. Some examples of services include, but are not limited to, utility services such as electrical and phone, cable television, insurance, and e-commerce.

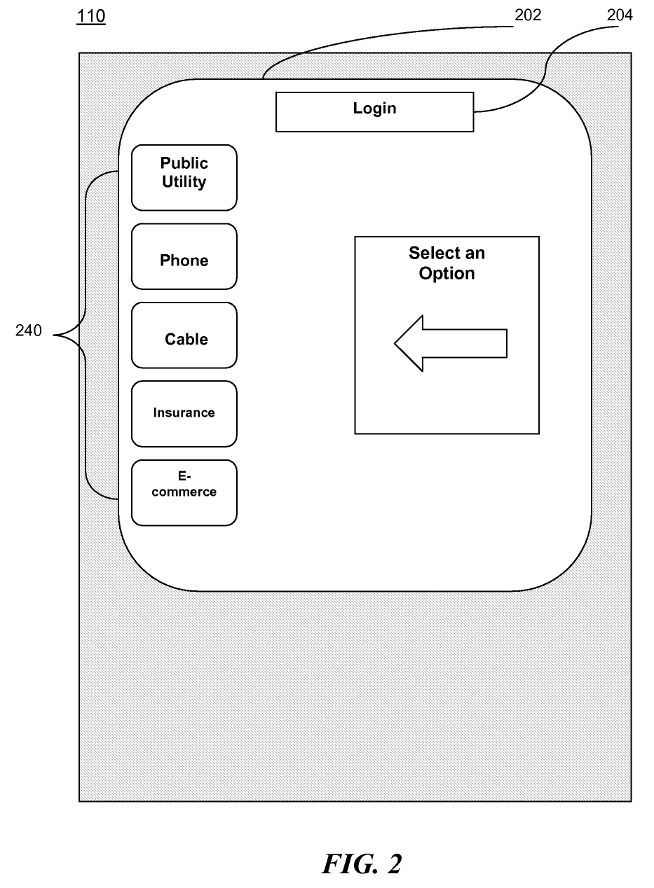

This method facilitates payment of services that would normally be very difficult for a non-banking consumer 102 to pay. Rather than going directly to the service provider 130 to make a payment with cash, the consumer 102 can secure a payment voucher 114 at a multimedia kiosk 110 (see FIG. 2) conveniently located within a commercial establishment 116 where the consumer 102 would normally shop. This establishment 116 may be a grocery store, pharmacy, or market, or other place of business. The kiosk 110 may be located in an airport. The only requirement is that the establishment 116 must have internet access.

The payment voucher 114 issued by the kiosk printer 112 is encoded with a barcode with the amount the consumer 102 wishes to pay, along with the account information, such as an account number. This encoded data is similar to the universal product code (UPC) associated with store products. The encoded payment voucher 114 is then brought to a store cashier 140 and submitted for payment in the same manner as any store product. The payment voucher 114 is run through a barcode reader at the cashier 140, and the price is scanned, just as with any retail product.

At this point the consumer remits to the cashier 140 the scanned price, completing the consumer 102 end of the transaction. The store 116 then remits the funds (usually by wire transfer) to the selected service provider 130. The service provider 130 receives the funds and credits the consumer's account. This completes the transaction.

The kiosk is shown in FIG. 2. The kiosk 110 comprises a screen 202 (preferably a touch screen). The touch screen 202 includes payment type indicators 250. These may include utility services, mobile phone services, cable television services, long distance services, insurance services, and e-commerce services. Indicators 250 may be selected by depressing the icon, manipulating a highlight bar and then depressing an ENTER key, or some other way that enables the selection of one payment type indicator 250 from among the others.

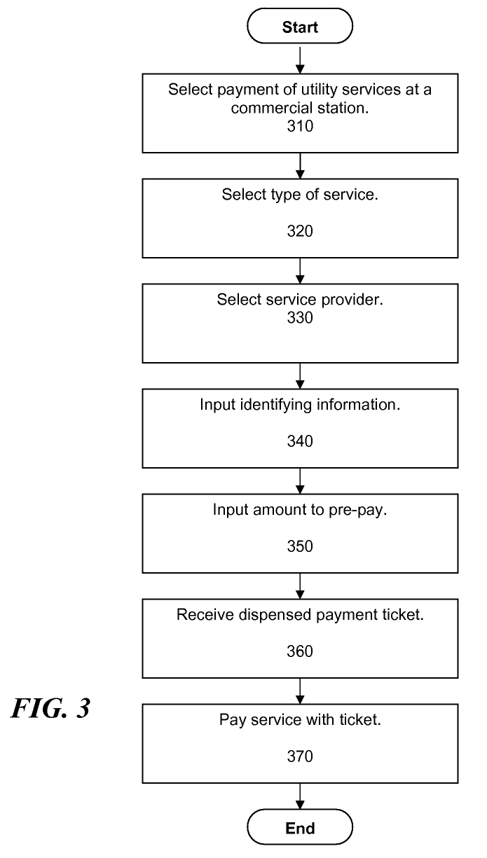

Referring to FIG. 3, a process for using the kiosk 110 is shown. In step 310 the kiosk 110 receives a request for making a payment from a consumer 102. This can be a simple activation of the kiosk 110 by touching the screen 202. In step 320 the kiosk 110 receives a selection of the type of service (product) 250 to be paid.

In step 330, the kiosk 110 receives an account number for the account of the consumer 102, in response to a prompt. The prompt may be something as simple as changing the kiosk screen 202 to a screen with an input text box labeled “account number.” Then in step 340 the identifying information is received from the consumer. In step 350 the amount of the payment is entered by the consumer 102. Optionally, the consumer 102 may be prompted to state whether the payment is a partial payment or a total payment. Lastly, the kiosk 110 prints out a ticket 114 in step 370.

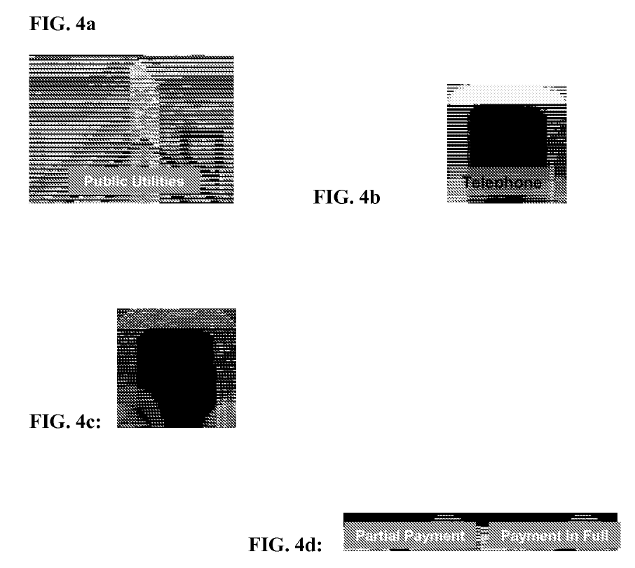

To commence the process the consumer 102 may first need to log in. Referring to FIG. 2, a login bar 204 may be displayed to the user 102 on the main menu, or the login may be on a separate screen, as shown in FIG. 4. To proceed, the user 102 touches, or otherwise selects, the login bar 204. In response, a touch screen keypad appears where the consumer 102 can enter a login ID and a password. Once securely logged in, the user 102 is presented with the payment type indicators 250.

In one embodiment of the invention, the account information may be provided to the kiosk 110 from the service provider 130 by means of a link or virtual private network. The account state or personal identification numbers (PINS) are provided periodically.

The first time that a consumer 102 uses the payment service the consumer 102 is prompted to create a profile. This is not mandatory. If the consumer 102 expects to use the system 100 on a regular basis, the consumer 102 may wish to set up a profile on the system 100. To create the profile, the consumer 102 is prompted to enter a login and password and some other information, such as a name and contact information. Optionally, the consumer's account information with the service provider 130 may also be obtained. Once registered (by supplying a login and password), the consumer 102 is automatically presented with his/her data at login. Once the profile is created, it can be accessed by providing an identification number and login.

Referring to FIG. 4a, a service selection icon 250 is illustrated. Once the consumer 102 has logged in he/she is presented with the selection of one of various choices of services displayed. To select an electrical power utility, the consumer 102 selects utility services FIG. 4a. Once the consumer 102 has selected the service to pay, the consumer 102 must then select the organization providing this service. This is only valid if there is more than one service provider for that service. For example, if the consumer 102 selects telephone services, shown in FIG. 4b, then on the next screen the consumer 102 must select from among telephone companies by selecting the icon representing that company (shown in FIG. 4c).

This can also be done by using a touch screen, or selecting from a drop-down menu. Other selection methods can be employed within the spirit and scope of the invention. On the next screen the consumer 102 enters his/her account number which in this case may be the telephone number. Optionally, other identification information may substitute for an account number, such as a driver's license number, national identification card. Next, the consumer 102 is prompted to select either a total payment or a partial payment as shown in FIG. 4d. Next, the consumer 102 enters the payment amount. Note that in the case of a mobile telephone number a mobile phone account may be credited (top up) or a new amount of calls can be provided.

Once the account number is entered and received, the consumer 102 is prompted to select either a payment in full or a partial payment. If the consumer 102 elects to pay in full the amount owed is shown and the consumer 102 may accept it. Once this is done the kiosk 110 prints out a payment voucher 114 with a bar code representing the information entered. The consumer 102 may then take the payment voucher 114 to a cashier 140 at the store 116 and pay in cash or its equivalent and the store 116 remits the funds to the service provider account for this amount. Note that, just as in many store transactions, the service may be paid for with a gift card, store card, or coupon. The consumer 102 may use any method of payment accepted by the store as legal tender. This may include federal assistance checks, provided they are accepted at the store 116.

In another embodiment, a kiosk 110 is configured for dispensing payment vouchers 114 for pre-payment of services such as mobile phone charges and long distance calls. This system lends itself to paying for popular pay-per-view services, such as those provided through television channels. Assume the consumer 102 wishes to pay for a pay-per-view event, but the consumer 102 does not have a credit card. With this system, the consumer 102 can simply pre-pay for the pay-per view event at the kiosk 110. For this embodiment, the kiosk 110 must be configured to receive cash. Once the consumer 102 pays for the pay-per-view event, then the kiosk 110 notifies the service provider 150 that payment was received for a pay-per-view event associated with the consumer's account. The service provider 150 authorizes the event for that consumer's account.

In another embodiment of the present invention, the kiosk 110 is embodied in virtual form as part of a website. This “virtual kiosk 110” is easily accessed by any computer with internet access. Assume the consumer 102 has a computer or has access to a computer, but does not have a credit card account with which to engage in e-commerce. In this situation, the consumer 102 can use a computer to access a website for electronic payment using the payment voucher system as discussed above. This website performs the role of the kiosk 110. The consumer 102 can log in to the website, and make the same selections as are available in the kiosk 110. Rather than a touch screen, the computer's keyboard and mouse can be used to input information and navigate from screen to screen.

If the consumer 102 has a computer configured for internet access but does not have internet access in his/her home, the consumer 102 can access the internet in a public place such as a library or an internet café “hot zone” which are easily accessed by the public. Once an internet connection is established, the consumer 102 uses a web browser to access the proprietary website for voucher payment. Using a computer interface such as a computer display screen, the consumer 102 can make all of the same payment options as with the kiosk 110. Using a computer's connection to a printer, the consumer 102 can print out a bar-coded payment voucher 114 on printer paper. This is similar to the online payment vouchers generated for the purchase of on-line concert tickets. This printed payment voucher 114 can then be taken to a store cashier 140 to pay for the service.

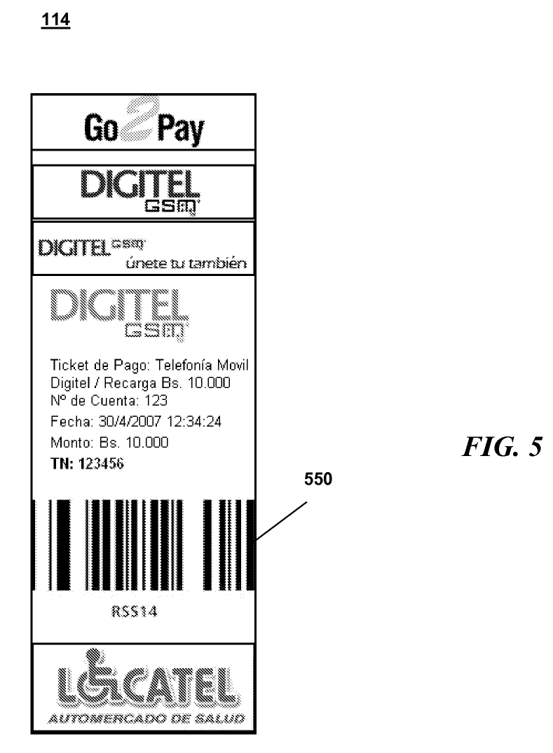

FIG. 5 shows an exemplary embodiment of the payment voucher 114. Prominently featured on the payment voucher 114 is the barcode 550. The barcode 550 is produced using conventional electronic means. The data encoded in the barcode 550 may be limited to the amount to pay and an account number, or the data may include additional information, such as a timestamp.

Referring to FIG. 6 there is shown a simplified block diagram of an information processing system (the kiosk 110) consistent with an embodiment of the present invention. For purposes of this invention, the kiosk 110 may represent any type of information processing system or other programmable electronic device, including a client computer, a server computer, or a portable computer. The computer system 110 may be a stand-alone device or networked into a larger system.

The kiosk 110 could include a number of operators and peripheral devices as shown, including a processor 602, a memory 604, and an input/output (I/O) subsystem 606. The processor 602 may be a general or special purpose microprocessor operating under control of computer program instructions executed from a memory 604. The processor 602 may include a number of special purpose sub-processors, each sub-processor for executing particular portions of the computer program instructions.

Each sub-processor may be a separate circuit able to operate substantially in parallel with the other sub-processors. Some or all of the sub-processors may be implemented as computer program processes (software) tangibly stored in a memory 604 that perform their respective functions when executed. These may share an instruction processor, such as a general purpose integrated circuit microprocessor, or each sub-processor may have its own processor for executing instructions. Alternatively, some or all of the sub-processors may be implemented in an application-specific integrated circuit (ASIC). Random access memory (RAM) may be embodied in one or more memory chips.

The memory 604 represents either a random-access memory or mass storage. It can be volatile or non-volatile. The kiosk 110 can also include a magnetic media mass storage device 624 such as a hard disk drive.

The I/O subsystem 606 may comprise various end user interfaces 630 such as the touch screen display 202, a keyboard, and a mouse and/or stylus. Additionally, the kiosk 110 may be coupled with the printer 112 for printing the payment vouchers 114. In an alternative embodiment, the kiosk 110 does not include an on-board printing device, but rather is operatively connected (by cable perhaps) to a printer.

The I/O subsystem 606 may further include a connection 616 to a network such as a local-area network (LAN) or wide-area network (WAN) such as the Internet 106. Processor and memory components may be physically interconnected using conventional bus architecture 610. It should be noted that the above is not an exhaustive list of all of the components and peripherals that may be part of the kiosk 110. What has been shown and discussed is a highly-simplified depiction of a programmable computer apparatus 110. Those skilled in the art will appreciate that a variety of alternatives are possible for the individual elements, and their arrangement, described above, while still falling within the scope of the invention.

The services as described above are preferably provided free of charge to the consumer 102. In one embodiment, the service providers 130 pay a per-transaction fee for the service. In another embodiment, a service provider 103 may subscribe to the service and pay a monthly subscription fee. Other fee payment structures are possible within the spirit and scope of the invention.

Therefore, while there has been described what is presently considered to be the preferred embodiment, it will understood by those skilled in the art that other modifications can be made within the spirit of the invention.

We claim:

1. An electronic method for facilitating payment for a service provided by a service provider, the method comprising steps of:
receiving a request from a consumer for processing the payment for the service at a commercial station;
receiving a selection of the service to be paid;
receiving account information for the service provider;
receiving an amount of the payment; and
providing a payment voucher to the consumer, said payment voucher to be used as payment to the service provider for the service, wherein said payment voucher comprises the amount of the payment, and the account information.

2. The method of claim 1 wherein the services are utility services.

3. The method of claim 1 wherein the services are cable television services.

4. The method of claim 1 wherein the services are e-commerce services.

5. The method of claim 1 wherein the services are insurance services.

6. The method of claim 1 wherein the commercial station is an electronic multimedia kiosk.

7. The method of claim 1 wherein the commercial station is embodied in a website accessible to the consumer.

8. The method of claim 1 wherein providing the payment voucher comprises printing a ticket comprising a barcode.

9. The method of claim 1 wherein the commercial station is coupled with a cashier, and the method further comprises steps of:
receiving funds from the consumer as payment for the service; and
remitting the funds to the service provider.

10. The method of claim 9 wherein the payment is an advance payment for the service.

11. The method of claim 10 wherein the service is selected from a group consisting of: a pay-per-view event, a cellular phone, utilities, and long distance charges.

12. The method of claim 1 further comprising receiving identifying information from the consumer.

13. The method of claim 1 wherein the service provider pays for the electronic method.

14. The method of claim 1 further comprising a step of:
receiving a name of the service provider after selecting the service to be paid.

15. The method of claim 14 wherein the step of providing account information comprises a step of:
entering an account number for the service, the account number corresponding to the service provider.

16. An apparatus for facilitating payment for a service provided by a service provider, the apparatus comprising:
an input/output interface configured to receive payment information from a consumer, wherein the input/output interface comprises a display for receiving said payment information;
the display comprising navigable screens for soliciting and receiving the payment information from the consumer;
an internet connection configured to access service provider accounts;
a memory comprising logic for carrying out instructions pursuant to the payment information provided; and
a processor operatively connected to the memory and the input/output interface, said processor configured to:
receive a selection of the service to be paid;
receive account information for the service provider of the service;
receive an amount of the payment; and
transmit the amount and the account information to a printer for providing a payment voucher to the consumer.

17. The apparatus of claim 16 coupled with the printer.

18. The apparatus of claim 16 wherein the display is a touch screen display.

19. The apparatus of claim 16 operatively coupled with a cashier configured for processing remittance of the payment voucher.

20. A system for paying a service provider for services, the system comprising:
a user interface for receiving user information, payment information, and account information relating to the services;
a communication interface for communicating with the service provider; and
a printer for printing a payment voucher comprising the payment information and the account information.

21. The system of claim 20 comprising a multimedia kiosk located in a commercial establishment.

22. The system of claim 21 further comprising a cashier for crediting the service provider with the payment amount.

23. The system of claim 20 wherein the service provider is a pay per view television provider and wherein the consumer purchases pay per view services.
